(19) United States
(12) Patent Application Publication
(10) Pub. No.: US 2009/0186731 A1
(43) Pub. Date: Jul. 23, 2009

(54) SILENT CHAIN

(75) Inventor: Takashi Tohara, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/335,677

(22) Filed: Dec. 16, 2008

(30) Foreign Application Priority Data
Jan. 23, 2008 (JP) 2008-012590

(51) Int. Cl. F16G 13/04

(52) U.S. Cl. 474/213

(57) ABSTRACT

In a silent chain having guide rows composed of guide plates, and inner guide row plates, and connected, by connecting pins, in alternating, interleaved relationship with plates of non-guide rows, the pitches of the pin holes in the plates of each non-guide row vary with increasing distance from the guide plates. Optionally the pitches of the inner plates in the guide rows can also vary with increasing distance from the guide plates. The pin holes of the non-centrally located non-guide row plates, and optionally, the pin holes of the non-centrally located inner guide row plates, can also be slanted to conform to the surfaces of the connecting pins when the pins are flexed as a result of tensile force applied to the chain.

### CROSS-REFERENCE TO RELATED APPLICATION

This application claims priority on the basis of Japanese patent application 2008-012590, filed Jan. 23, 2008. The disclosure of Japanese application 2008-012590 is hereby incorporated by reference.

### FIELD OF THE INVENTION

This invention relates to a silent chain having improvements by which the forces that act on the link plates as a result of tension applied to the chain are more uniformly distributed.

### BACKGROUND OF THE INVENTION

A typical silent chain comprising rows of plates, defined as guide rows and non-guide rows respectively. Each guide row is composed of a pair of opposed guide plates and a plurality of inner guide row plates disposed between the guide plates. Each of the inner guide row plates has a pair of pin holes. Each non-guide row is composed of a plurality of non-guide row plates, and each of the non-guide row plates also has a pair of pin holes. The number of non-guide row plates in each non-guide row exceeds, by one, the number of inner guide row plates in each guide row. The guide rows and non-guide rows are arranged alternately along the length of the chain, and the plates of the each non-guide row are interleaved with the plates of two adjacent guide rows and extend between the guide plates of the adjacent guide rows. Connecting pins, which are fixed to the guide plates, extend through pin holes in the interleaved inner guide row plates and non-guide row plates in order to connect the guide rows and the non-guide rows in articulating relationship.

As shown in FIGS. 11 and 12, the conventional silent chain 500 has a guide row 520 composed of a pair of guide plates 521 and 522, a plurality of inner guide row plates 526, 527, 528 and 529 arranged between the guide plates 521 and 522, and a non-guide row 530 composed of inner link plates 531, 532, 533, 534 and 535, the number of which exceeds by one the number of inner link plates in the guide row 520. The plates of the non-guide row are interleaved with the plates of the guide row. Pins 511 and 512 are securely fitted into pairs of front and rear pin holes 551, 552, 561 and 562 of the respective guide plates 521 and 522, and extend loosely through holes in the link plates 526, 527, 528, 529, 531, 532, 533, 534 and 535 so that the guide rink row 520 and the non-guide row 530 are connected but articulable.

The pitch P of the connecting pins 511 and 512 is the same as that of the pin holes of the inner guide row plates 526, 527, 528 and 529. Equal annular clearances C exist between outer circumferential surfaces of the pins 511 and 512 and the inner circumferential surfaces of pin holes 551, etc., of the respective inner link plates 526, 527, 528 and 529.

When a tensile force acts on the silent chain 500, deflection occurs in the pins 511 and 512. As the deflections of the pins 511 and 512 increase, the pins come into abutting contact with the inner circumferential surfaces of the pin holes of the inner link plates 527 and 528, which are farthest from the outer link plates.

The tensile load becomes concentrated in the guide plates 521 and 522 and in the inner guide row plates 527 and 528. On the other hand, in the non-guide link row 530, tensile forces are concentrated in the outermost link plates 531 and 535 as a result of deflections of the pins 511 and 512, as explained in U.S. Pat. No. 5,989,141.

However, the conventional silent chain, wear, elongation and rupture are liable to occur in the link plates in which the load is concentrated. To increase the plate strength, countermeasures such as increasing the plate thickness can be adopted. However, in the case of a chain used in the valve timing system of an engine, for example, where compactness and lightness in weight are important, increasing plate thickness has not been a satisfactory solution.

Another problem was flexion of the connecting pins as a result of tensile loads applied to the chain caused a concentration of load on the edges of the pin holes of the plates, causing wear, chain elongation, and rupture of the plates.

Accordingly, an object of the invention is to solve the above-described problems and to provide a silent chain, which is light in weight, compact, and torque resistant, and in which tensile force is more uniformly distributed despite deflection of the connecting pins, so that wear, elongation and the likelihood of rupture, are reduced.

### SUMMARY OF THE INVENTION

The silent chain according to the invention comprising rows of plates, defined as guide rows and non-guide rows respectively. Each guide row is composed of a pair of opposed guide plates and a plurality of inner guide row plates disposed between the guide plates. Each of the inner guide row plates has a pair of pin holes. Each non-guide row is composed of a plurality of non-guide row plates, and each of the non-guide row plates also has a pair of pin holes. The number of non-guide row plates in each non-guide row exceeds, by one, the number of inner guide row plates in each guide row. The guide rows and non-guide rows are arranged alternately along the length of the chain, and the plates of the each non-guide row are interleaved with the plates of two adjacent guide rows and extend between the guide plates of the adjacent guide rows. Connecting pins extend through pin holes in the interleaved inner guide row plates and non-guide row plates in order to connect the guide rows and the non-guide rows in articulating relationship. The chain is characterized by the fact that the pitches of the pin holes in the plates of each non-guide row vary with increasing distance from the guide plates.

When a tensile force is exerted on the silent chain, causing its pins to be flexed, the tensile force is substantially uniformly transmitted to the link plates of the non-guide link row. Therefore, concentration of load on specific link plates is avoided. Wear, chain elongation, and likelihood of rupture are reduced. Moreover, these effects can be achieve in a chain that is both light in weight and compact, and that exhibits high torque resistance.

The pin holes of the link plates of the non-centrally located non-guide link rows are preferably slanted whereby, when the connecting pins are flexed by tension applied to the chain, in each pin hole of the link plates of the non-guide link rows, the inner peripheral surface thereof more closely conforms to the surface of the connecting pin extending therethrough. In other words, the inclination of the inner circumferential surfaces of the pin holes follows the deflection of the pin so that contact pressure is not concentrated on sharp edges of the pin holes, and wear, chain elongation, and the likelihood of rupture are further reduced.

In an alternative embodiment, the pitches of the pin holes in the plates of each guide row can also vary with increasing distance from the guide plates. Therefore concentration of load on specific inner link plates of the guide rows is avoided, and wear, chain elongation, and likelihood of rupture are still further reduced.

As in the case of the non-guide row plates, the pin holes of the non-centrally located inner link plates of the guide rows can also be slanted whereby, when the connecting pin is flexed by tension applied to the chain, in each pin hole of the link plates of the guide rows, the inner peripheral surface thereof more closely conforms to the surface of the connecting pin extending therethrough, so that contact pressure is not concentrated on sharp edges of the pin holes, and wear, chain elongation, and the likelihood of rupture are still further reduced.

### BRIEF DESCRIPTION OF THE DRAWINGS

FIG. 1 is a side elevational view of a part of a silent chain according to the invention;

FIG. 2 is a plan view of a portion of the chain;

FIG. 3 is a side elevational view of a guide plate of the chain;

FIG. 4 is a cross-sectional view of a first embodiment of a silent chain according to the invention;

FIG. 5 is an elevational view of a toothed link plate in a guide link row of the silent chain of FIG. 4;

FIG. 6 is a set of elevational views of the link plates of a non-guide link row of the chain of FIG. 4;

FIG. 7 is an exaggerated cross-sectional view of the chain of FIG. 4, illustrating the bending of the connecting pins of the chain when the chain is under tension;

FIG. 8 is a cross-sectional view of a second embodiment of a silent chain according to the invention;

FIG. 9 is a set of elevational views of the link plates of a guide link row of the chain of FIG. 8

FIG. 10 is a cross-sectional view of the chain of FIG. 8, illustrating the bending of the connecting pins of the chain when the chain is under tension;

FIG. 11 is a cross-sectional view of a conventional silent chain; and

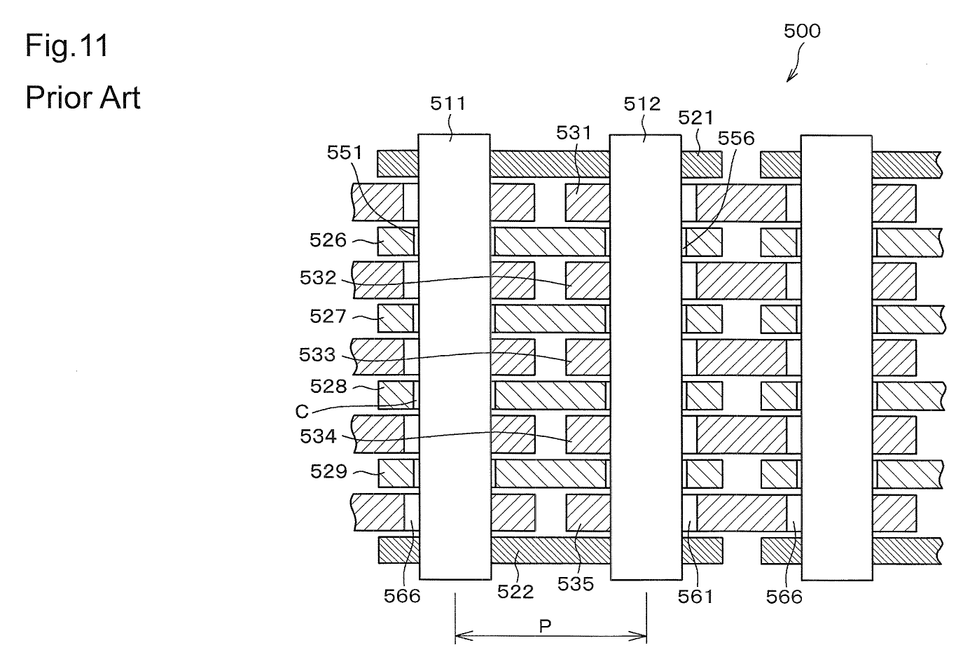

FIG. 12 is a cross-sectional view illustrating the bending of the connecting pins of the conventional chain when the chain is under tension.

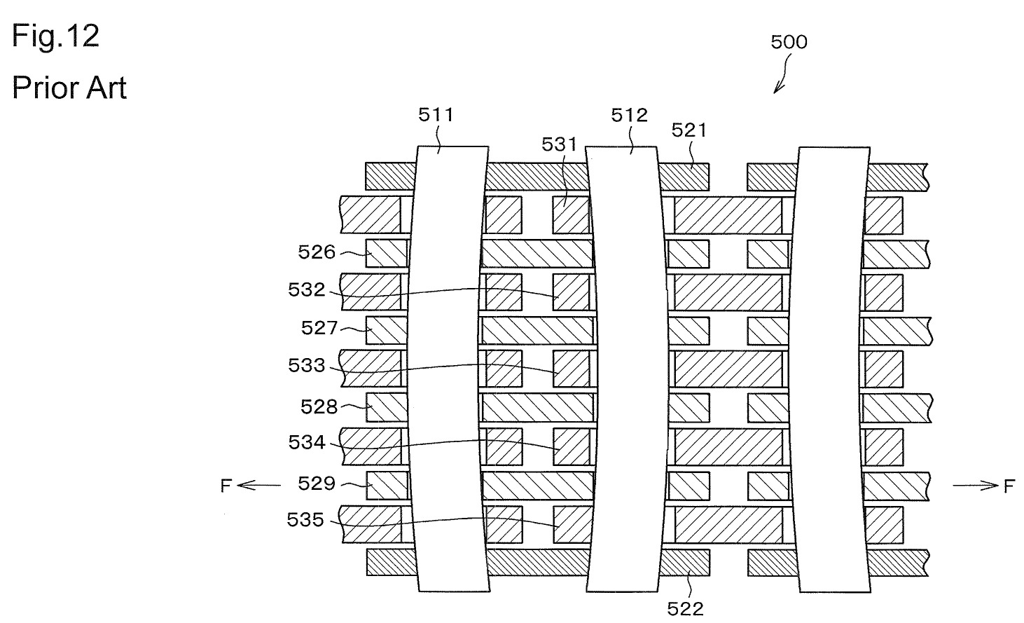

### DETAILED DESCRIPTION OF THE PREFERRED EMBODIMENTS

In the chain according to the invention, the pitches of the pin holes of the non-guide row plates, and, optionally, the pitches of the pin holes of the inner guide row plates, vary according to the distance from the guide plates of the chain. Varying the pitches of the pin holes tends to equalize the forces applied to the link plates when the connecting pins are deflected as a result of tension applied to the chain.

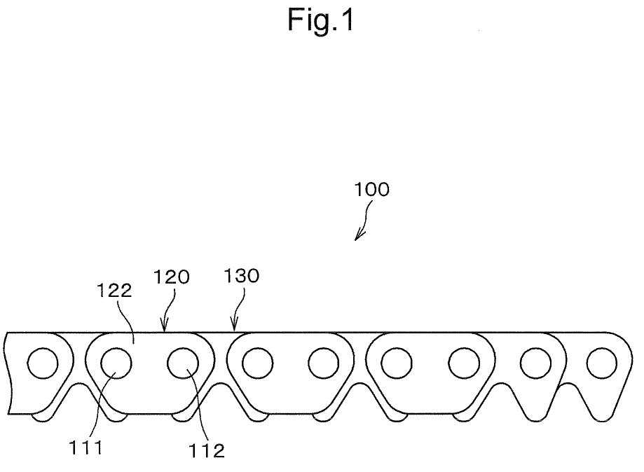

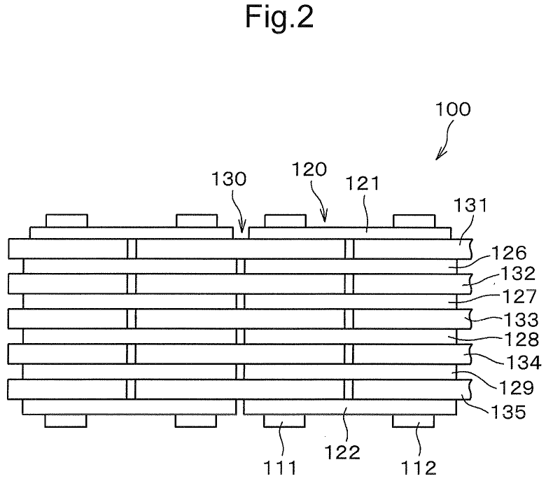

As shown in FIGS. 1 to 3, in a silent chain 100, a guide link row 120 is composed of a pair of guide plates 121 and 122 and a plurality of toothed inner link plates 126, 127, 128 and 129, arranged between the guide plates 121 and 122. A non-guide link row 130 is composed of toothed link plates 131, 132, 133, 134 and 135, the number of which exceeds, by one, the number of inner link plates 126, 127, 128 and 129 of the guide link row 120. The guide rows and non-guide rows are arranged alternately along the length of the chain, and the plates of the non-guide rows are interleaved with the plates of the guide rows.

Connecting pins 111 and 112 are respectively inserted into and fixed to, front and rear pin holes of the guide plates 121 and 122. Each pin extends through pin holes of the link plates 126, 127, 128, 129, 131, 132, 133, 134 and 135, connecting the interleaved rows of plates together while allowing articulation of the chain.

The inner diameters of pin holes 123 and 124 in the respective guide plate 121 and 122 are smaller than the outer diameters of pins 111 and 112. And the pins 111 and 112 are press-fit into the guide plates 121 and 122. Further, the inner diameters of the pin holes of the inner link plates of the guide rows 120 and the inner diameters of the pin holes of the link plates of the non-guide link rows 130 are larger than the outer diameters of pins 111 and 112 so that toothed link plates can rotate relative to the connecting pins.

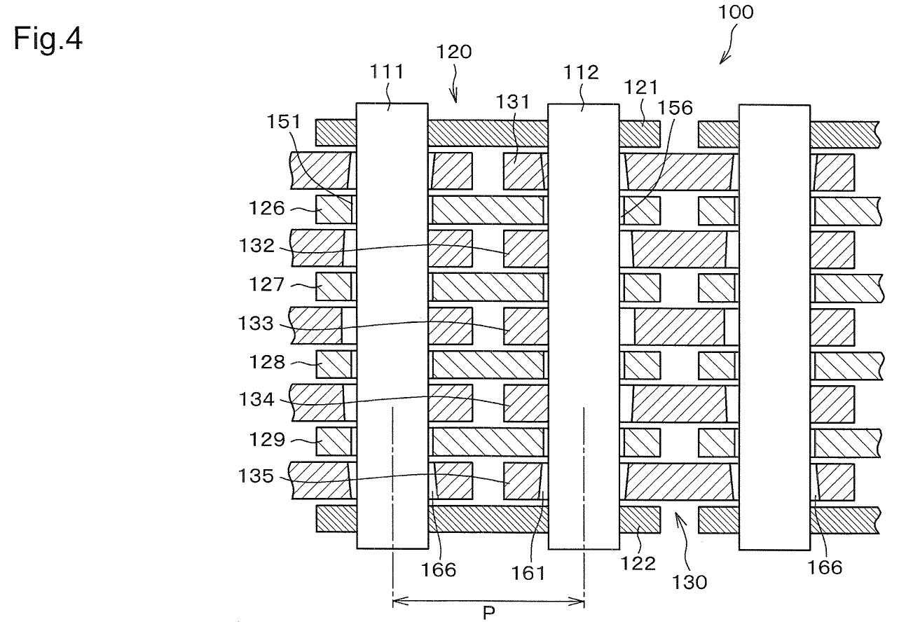

As shown in FIG. 4, the pitches of the pairs of front and rear pin holes of the inner link plates 126, 127, 128 and 129 of the guide row 120 are uniform, whereas the pitches of the pairs of front and rear pin holes of the link plates 131, 132, 133, 134 and 135 of the non-guide link row 130 vary from each other in accordance with the distance of link plates 131, 132, 133, 134 and 135 from the respective guide plates 121 and 122.

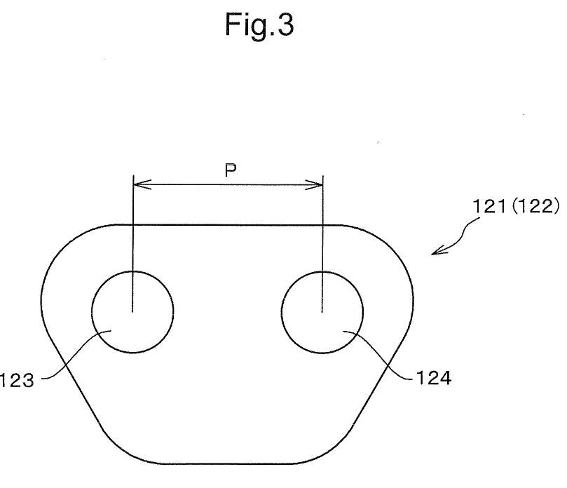

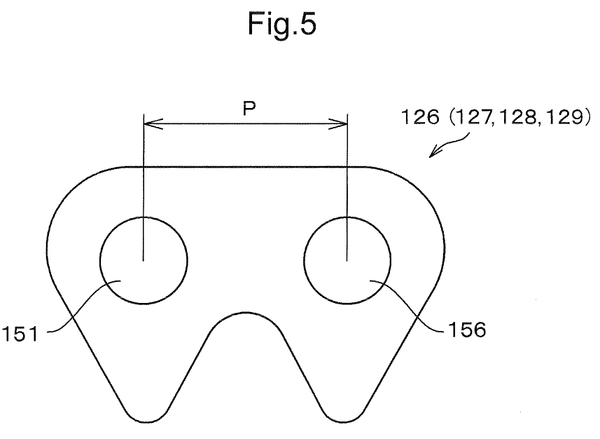

The inner link plates 126, 127, 128 and 129 of the guide link row 120 are all the same size, and, as shown in FIG. 5, the pitch P of the front and rear pin holes 151 and 156 of each of plates 126, 127, 128 and 129 is the same as the pitch P of the front and rear pin holes 123 and 124 of the guide plate 121 and 122, as shown in FIG. 3. This pitch P is the same as the pitch of the connecting pins 111 and 112 when relaxed, as shown in FIG. 4.

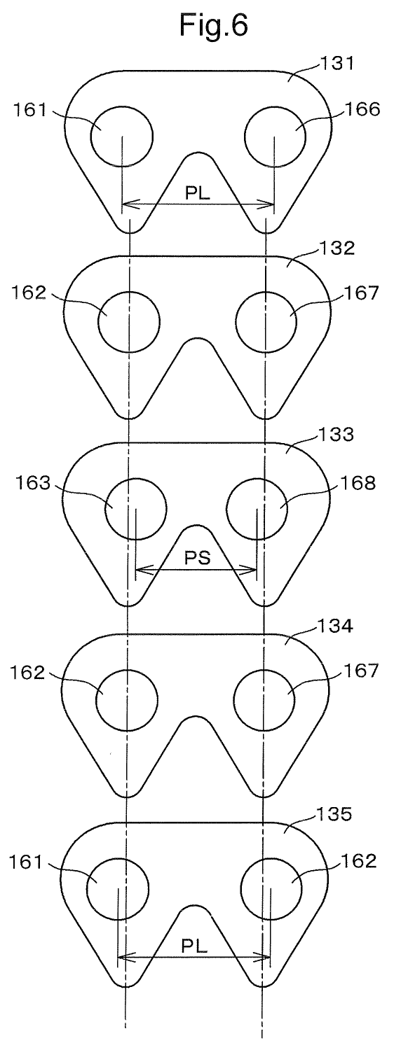

As shown in FIG. 6, in the link plates 131, 132, 133, 134 and 135 of the non-guide link row 130, the pitch PL of the front and rear pin holes 161 and 166 of link plates 131 and 135, which are the closest to the guide plates 121 and 122, is larger than the pitch P of the front and rear pin holes 123 and 124 of the guide plates 121 and 122. The pitch PS of the front and rear pin holes 163 and 168 of the innermost link plate 133, which is farthest from the guide plates 121 and 122, is smaller than the pitch P. The pitch of the front and rear pin holes 162 and 167 of link plates 132 and 134, however, are the same as the pitch P. Thus, the pitches of the pin holes in the non-guide link row decrease with increasing distance from the guide plates.

As shown in FIG. 4, the inner peripheral surfaces of the pin holes in the link plates of the non-guide link rows 130, other than the centrally located link plates 133, are slanted, in order to conform to the shapes of the connecting pins when the pins are flexed as a result of tension applied to the chain. The pin holes of the central link plate need not be slanted, because the central portions of the connecting pins do not become inclined when the pins are flexed

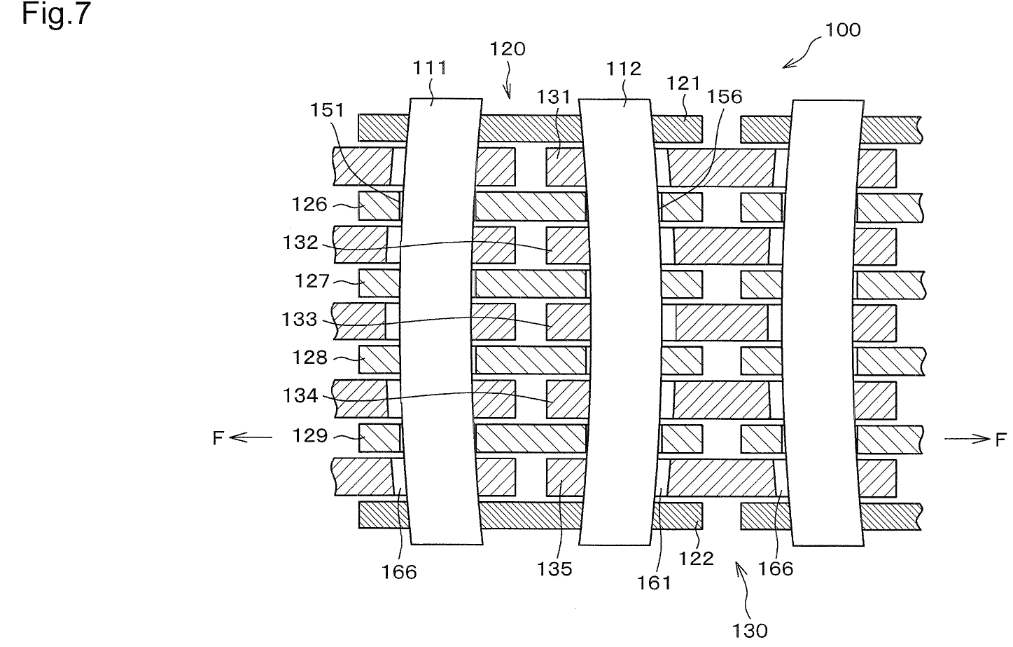

When tensile force is exerted on the silent chain 100, as shown in FIG. 7, the pins 111 and 112 in a guide row 120 flex so that their central portions bulge away from each other. However, since the pitch of the front and rear pin holes of the non-guide row link plates decreases with increasing distance from the guide plates, the pin holes of the non-guide row 130 more uniformly contact the pins so that the tensile load is more uniformly shared by the plates of the non-guide row. Concentration of load on specific link plates is avoided, and wear, chain elongation, and likelihood of rupture are reduced. Moreover, the chain can be made light in weight, compact, highly resistant to torque, and stronger without increasing the thicknesses of the plates

As seen in FIG. 7, the front and rear pin holes of all the non-guide row link plates except for the central plates 133 are slanted to conform more closely to the surfaces of the connecting pins that extend through them when the chain is under the degree of tension ordinarily encountered during power transmission. When a tensile force is exerted on the chain, the surfaces of pins 111 and 112 conform closely to the inner peripheries of the pin holes, and concentrations of load are reduced. Thus, the load exerted by a pin on any given non-guide row link plate is distributed across the width of the link plate, and wear, elongation and the likelihood of rupture are further reduced.

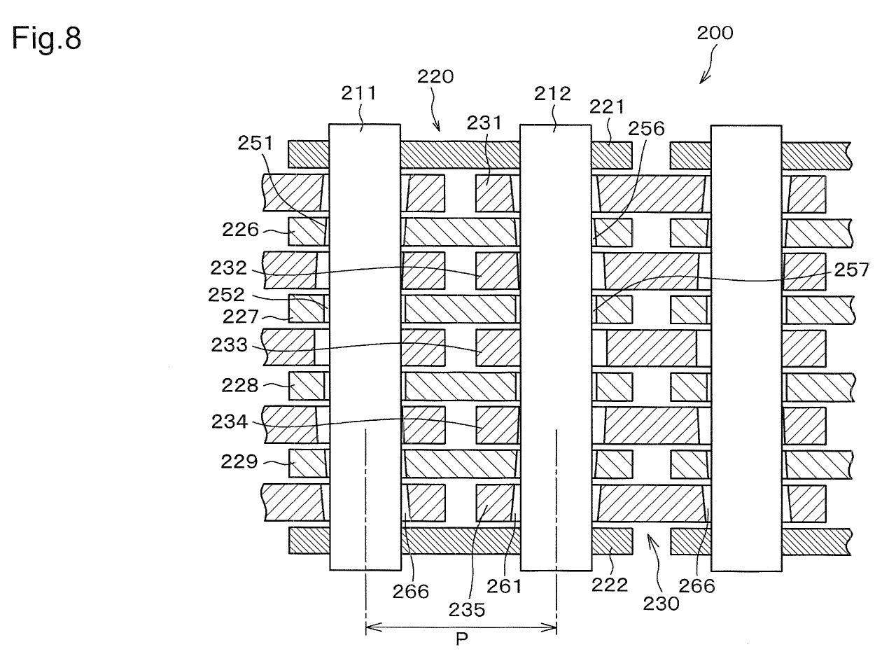

In a second embodiment, shown in FIG. 8, a silent chain 200 comprises non-guide row link plates 231, 232, 233, 234 and 235, the pin holes of which have a pitch variation as in the first embodiment, and guide rows 220, in which the guide row link plates 226, 227, 228 and 229 also have pin holes with pitches that vary in accordance with distance from the guide plates 221 and 222.

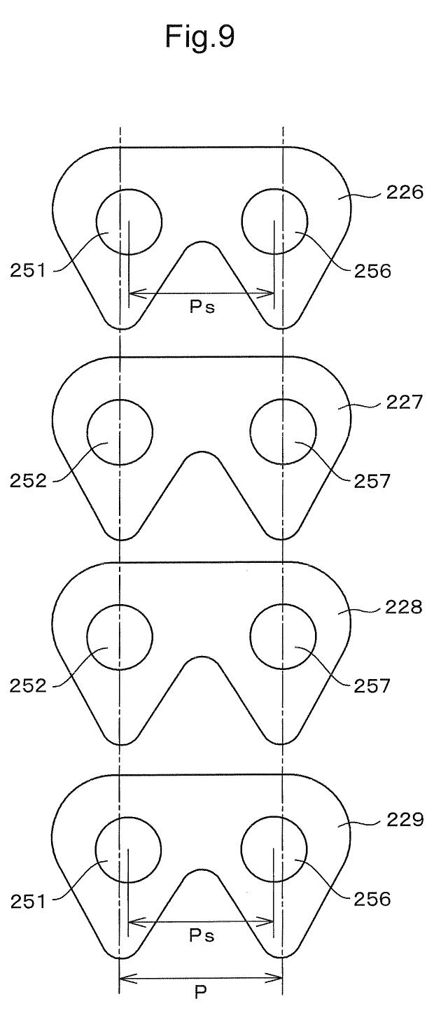

In the inner link plates 226, 227, 228 and 229 of the guide link row 220, as shown in FIG. 9, the pitch Ps between respective front and rear pin holes 251 and 256 of inner link plates 226 and 229, which are the closest to the guide plates 221 and 222 respectively, is less than the pitch P of the front and rear pin holes 223 and 224 of the guide plates 221 and 222. The pitch of the front and rear pin holes 252 and 257 of the inner link plates 227 and 228, which are farther from the guide plates 221 and 222 is the same as the pitch P of the pin holes of the guide plates. Thus, in the case of the inner link plates of the guide rows, the pitch increases with increasing distance from the guide link plates.

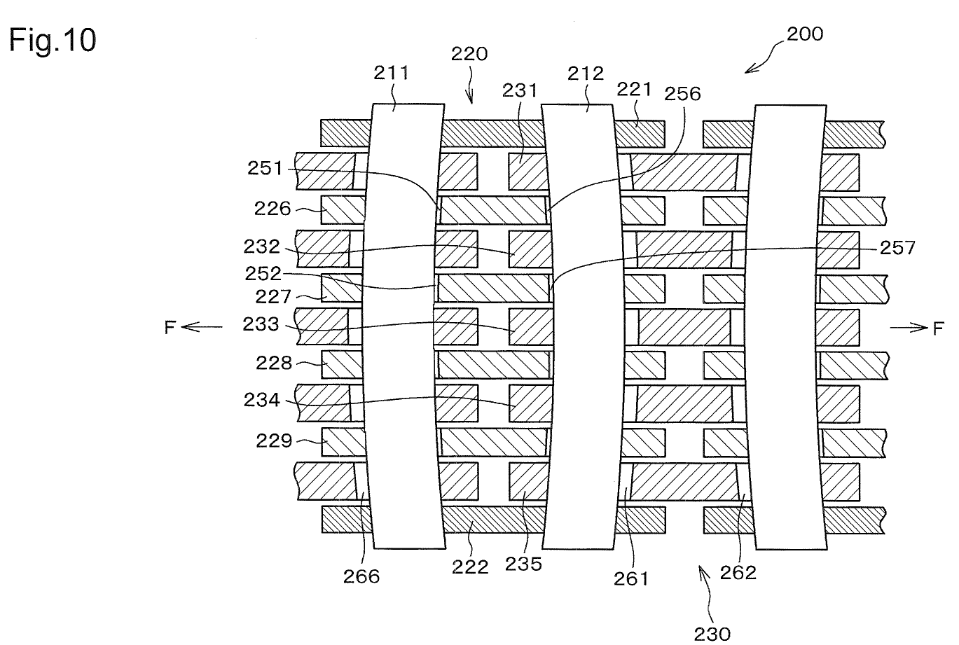

The holes of the non-guide row link plates 231, 232, 233, 234 and 235 have the same pitch relationship as that of the guide plates in the first embodiment, as shown in FIG. 6. That is, the pitch decreases with increasing distance from the guide plates. As shown in FIGS. 8 and 10, the pin holes of the non-guide row plates, other than the centrally located plate, are slanted as in the case of the first embodiment. The pin holes 251, 256, 252, 257, 261, 266, 262 and 267 of the inner link plates 226, 227, 228 and 229 of the guide link rows 220 are also slanted so that they more closely conform to the surfaces of the connecting pins at the contact locations when the pins are flexed as a result of tension applied to the chain. In the case shown, the number of inner guide row plates is even. Thus, all of the inner guide row plates have slanted pin holes, and the only plates having holes that are not slanted are the centrally located plates 233 of the non-guide link rows 230.

The chain can, of course, have an odd number of inner guide row plates, in which case, the centrally located guide row plate preferably has holes that are perpendicular to the faces of the plates. Moreover, in such a case, the number of non-guide row plates will ordinarily be even, and all of the non-guide row plates will have slanted pin holes.

When tensile force is exerted on the silent chain 200, as shown in FIG. 10, the connecting pins 211 and 212 of each guide row 220 are flexed in such a way their central portions bulge away from each other. However, as a result of the above-describe variations in the pitches of the pin holes of the link plates in both the non-guide rows and the guide rows, the tensile load is more uniformly shared among the plates of the guide rows as well as among the plates of the non-guide rows. Thus, still further improvements in resistance to wear, elongation and rupture can be realized. Here again, as in the first embodiment, a chain which is lightweight and compact, and which exhibits high torque resistance, can be obtained without increasing its plate thickness in order to achieve adequate strength.

Furthermore, as a result of the inclination of the pin holes both in the non-guide rows and in the guide rows, the pin holes in both the guide rows and in the non-guide rows conform more closely to the surfaces of the pins when the pins are flexed. Load concentrations are reduced, and the load on each pin hole is more uniformly distributed, thus reducing the likelihood of rupture.

In the embodiments described, the pitches of the front and rear pin holes of particular link plates are equal to the pitches of the front and rear holes of the connecting pins. It should be understood, however, that the pitches of the holes in the link plates can be selected depending on materials, pin size, flexion characteristics of the connecting pins, conditions of use, etc., and that chains according to the invention can be made without any of the non-guide row plates and inner guide row plates having a pin-hole pitch equal to the pitch of the pin holes in the guide plates.

I claim:

1. A silent chain comprising:
guide rows, each composed of a pair of opposed guide plates and a plurality of inner guide row plates disposed between said pair of guide plates, each of said inner guide row plates having a pair of pin holes;
non-guide rows, each composed of a plurality of non-guide row plates, each of said non-guide row plates also having a pair of pin holes;
the number of non-guide row plates in each non-guide row exceeding by one the number of inner guide row plates in each guide row, the guide rows and non-guide rows being arranged alternately along the length of the chain, and the plates of the each non-guide row being interleaved with the plates of two adjacent guide rows and extending between the guide plates of said adjacent guide rows; and
connecting pins extending through pin holes in the interleaved inner guide row plates and non-guide row plates, said pins connecting the guide rows and the non-guide rows in articulating relationship;
wherein the pitches of the pin holes in the plates of each non-guide row vary with increasing distance from the guide plates.

2. A silent chain according to claim 1, wherein the pitches of the pin holes in the plates of each non-guide row decrease with increasing distance from the guide plates.

3. A silent chain according to claim 1, in which the pin holes of each non-centrally located link plate of the non-guide link rows are slanted whereby, when the connecting pins are flexed by tension applied to the chain, in each pin hole of the link plates of the non-guide link rows, the inner peripheral surface thereof more closely conforms to the surface of the connecting pin extending therethrough.

4. A silent chain according to claim 1, in which the pitches of the pin holes in the plates of each guide row also vary with increasing distance from the guide plates

5. A silent chain according to claim 2, in which the pitches of the pin holes in the plates of each guide row increase with increasing distance from the guide plates

6. A silent chain according to claim 3, in which the pitches of the pin holes in the plates of each guide row also vary with increasing distance from the guide plates.

7. A silent chain according to claim 6, in which the pin holes of the non-centrally located inner link plates of the guide rows are slanted whereby, when the connecting pins are flexed by tension applied to the chain, in each pin hole of the link plates of the guide rows, the inner peripheral surface thereof more closely conforms to the surface of the connecting pin extending therethrough.
